(19) United States
(12) Patent Application Publication
(10) Pub. No.: US 2003/0118264 A1
(43) Pub. Date: Jun. 26, 2003

(54) Polarization-maintaining optical waveguide and method for forming same

(76) Inventor: Makoto Fujimaki, Tsukuba-shi (JP)

Correspondence Address: WORKMAN NYDEGGER & SEELEY, 1000 EAGLE GATE TOWER, 60 EAST SOUTH TEMPLE, SALT LAKE CITY, UT, 84111, US

(21) Appl. No.: 10/307,728

(22) Filed: Dec. 2, 2002

(30) Foreign Application Priority Data
Dec. 3, 2001 (JP) 2001-369223

(51) Int. Cl. G02B 6/27; G02B 6/16

(52) U.S. Cl. 385/11; 385/123

(57) ABSTRACT

The present invention provides fabrication methods of a polarization-maintaining optical waveguide, which forms a polarization-maintaining structure in an optical waveguide (including an optical fiber) easily. The method forms one or more stress-applying parts in a cladding of an optical waveguide utilizing density change induced in the cladding by implanting ions accelerated with high acceleration energy into the cladding. If necessary, changing the acceleration energy of the ion beam, using masks, rotating the optical waveguide against the ion beam, implanting ions from various directions, and/or using various kinds of ions are preferable.

This application claims priority from Japanese Patent Application No. 2001-369223 filed Dec. 3, 2001, which is incorporated hereinto by reference.

### BACKGROUND OF THE INVENTION

1. Field of the Invention

The present invention relates to a polarization-maintaining optical waveguide that has one or more stress-applying parts, which apply a stress to an optical waveguide core, and a method for forming the polarization-maintaining optical waveguide.

2. Description of the Related Art

A polarization state of an input light is not maintained in a typical single-mode or a typical multimode optical fiber because of inequalities in the diameter of cores of the optical fiber along a longitudinal direction, vibrations, temperature changes, and the like, then there is a phenomenon in which the polarization state of an output light changes randomly. Therefore, when an ordinary optical fiber is utilized as an optical fiber sensor or a coherent optical communication that utilizes polarization states of light, the output light intensity changes with disturbances or temperature changes. An optical fiber used for the problem solving is a polarization-maintaining optical fiber (PMF), and one of the examples of a PMF is a PANDA fiber where the core existing at the center of the optical fiber has birefringence due to two stress-applying parts. (Reference 1: Polarization-Maintaining and Absorption-reducing, OFC' 82.)

The PMF is an optical fiber that maintains the polarization state of a light propagating in the core by forming birefringence in the core by applying a stress to the core by forming stress-applying parts in the optical fiber cladding. Generally, the stress-applying parts are formed to be symmetrical, or centro-symmetry, with respect to the center of the core. (Reference 2: T. Yajima, K. Shimoda, H. Inaba, and S. Nanba, New edition Laser Handbook, p. 449 (1997) in Japanese) Currently, the PMF is produced by inserting a material to be formed as the stress-applying parts into two or more even holes formed in the cladding of a preform rod to be symmetric with respect to a core of the rod, and then by drawing this preform rod into an optical fiber. (References 3, 4, 5, and 6: Japanese patent Nos. 1293813 and 1643426 and Japanese patent application laid-open Nos. 9-030824 (1997) and 6-347659 (1994)) However, the yield rate of the above-mentioned current PMF fabrication method is low, because of the difficulty of forming uniform holes into a long optical fiber preform rod along the longitudinal direction. Thus the yield rate is estimated to be less than 20%.

### SUMMARY OF THE INVENTION

To dissolve the problem above-mentioned with the current method, the object of the present invention is to provide a polarization-maintaining optical waveguide fabrication method for forming a polarization-maintaining structure in an optical waveguide more easily and a polarization-maintaining optical waveguide fabricated by the invented method.

In order to attain the above-mentioned object, a polarization-maintaining optical waveguide of the present invention comprises one or more stress-applying parts in a cladding of the optical waveguide formed by implanting accelerated ions into the cladding, and a core of the optical waveguide in which the stress due to the stress-applying part is applied.

Preferably, the stress-applying parts are formed at two or more even positions in the cladding to be centro-symmetry with respect the core.

Preferably, the stress-applying parts are formed at two or more even positions in the cladding to be line-symmetry with respect to a center line of the core.

In order to attain the above-mentioned object, a fabrication method of a polarization-maintaining optical waveguide of the present invention comprises the steps of generating accelerated ions and forming one or more stress-applying parts in a cladding of the optical waveguide that apply a stress to a core of the optical waveguide, by implanting the accelerated ions into the cladding.

Preferably, the fabrication method of the present invention forms the stress-applying parts at two or more even positions in the cladding to be centro-symmetry with respect to the core, at the stress-applying part forming step.

Preferably, the fabrication method of the present invention forms the stress-applying parts at two or more even positions in the cladding to be line-symmetry with respect to a center line of the core, at the stress-applying part forming step.

Preferably, a region in the optical waveguide where the ions are implanted is limited by using masks to block out the ions or by reducing the diameter of the accelerated ion beam, at the stress-applying part forming step.

Preferably, the accelerated ions are implanted into the optical waveguide through a plate that has a concave surface with a curvature which is the same or similar to a curvature of a surface of the optical waveguide, at the stress-applying part forming step.

Preferably, the stress-applying part is thickened by changing the acceleration energy of the accelerated ion beam at the stress-applying part forming step.

Preferably, plural layers of the stress-applying parts are formed by irradiating ion beams with mixed different acceleration energies, into the optical waveguide, at the stress-applying part forming step.

Preferably, the stress-applying part is thickened by rotating the optical waveguide against the ion beam at an angle less than 90 degrees, at the stress-applying part forming step.

Preferably, plural layers of the stress-applying parts are formed by implanting various kinds of ions at the stress-applying part forming step.

Preferably, a polarization-maintaining optical waveguide is fabricated by any one of the above-described polarization-maintaining optical waveguide fabrication methods.

The present invention forms the stress-applying part utilizing a density change induced in the claddings of optical waveguides (including optical fibers) by implanting ions accelerated with high acceleration energy into the claddings. Therefore, the present invention provides a fabrication method that forms the polarization-maintaining structure in an optical waveguide easily, and also provides the fabricated polarization-maintaining optical waveguide fabricated by the method.

The above and other objects, effects, features and advantages of the present invention will become more apparent from the following description of embodiments thereof taken in conjunction with the accompanying drawings.

### BRIEF DESCRIPTION OF THE DRAWINGS

FIG. 1A is a front view for explaining the principle of the present invention and showing the situation in which He ions accelerated with 5 MeV are implanted into a side of a single mode optical fiber to a dose of 3×10¹⁴ cm⁻², and FIG. 1B is a front view of the optical fiber after the ion implantation;

FIG. 2A is a drawing for explaining the principle of the present invention and illustrating the photograph of the cross section of an optical fiber showing the shape of a stress-applying part formed by implanting ions so that the implanted ions stop in the optical fiber cladding, and FIG. 2B is a conceptual diagram of FIG. 2A;

FIG. 3 is a conceptual view illustrating the process in the first embodiment of the present invention that forms the stress-applying parts to be symmetric with respect to an optical fiber core by irradiating ions to the optical fiber from two directions along the y axis;

FIG. 4 is a conceptual view illustrating the process in the second embodiment of the present invention that implants ions only around x=0 by using masks that block out the ions or by reducing the diameter of ion beams;

FIG. 5 is a conceptual view illustrating the process in the third embodiment of the present invention that forms the stress-applying parts at symmetric positions with respect to an optical fiber core by masking the position around x=0;

FIG. 6 is a conceptual view illustrating the process in the fourth embodiment of the present invention that forms birefringence in the core of an optical fiber by forming a pair of semicircular-shaped densified regions in the cladding of the optical fiber, which are on the other sides of the core opposite to the cladding surfaces that the ions are irradiated;

FIG. 7 is a conceptual view illustrating the process in the sixth embodiment of the present invention that thickens the stress-applying part by tilting the optical fiber 10 degrees against the ion beam (θ=10°) in the ion implantation condition illustrated in FIG. 5;

FIG. 8 is a conceptual view illustrating the process in the seventh embodiment of the present invention that forms birefringence in the core of an optical fiber by forming thick stress-applying parts, by using one-direction ion implantation with changing acceleration energies of ions and/or tilting the optical fiber against the ion beam; and

FIG. 9 is a conceptual view illustrating the process in the eighth embodiment of the present invention that forms the stress-applying parts centro-symmetry with respect to the core with one-direction ion implantation through a silica-glass plate that has a concave surface with a curvature which is the same as the curvature of the optical fiber surface.

### DETAILED DESCRIPTION OF PREFERRED EMBODIMENTS

First, the principle of the present invention is explained. In this article, the words ‘irradiation’ and ‘implantation’ are used similarly. If ions are irradiated into a material, then the ions are implanted into the material.

It has been well known that if accelerated ions are irradiated to silica-based glass, or SiO₂ glass, which is widely used as a material for optical waveguides, densification of the material is induced around the position where the ions stop. (Reference 7: Makoto Fujimaki et al. “Ion-implantation-induced densification in silica-based glass for fabrication of optical fiber gratings” Journal of Applied Physics Vol. 88, No. 10, pp. 5534-5537, Nov. 15, 2000.) When ions are irradiated to a part of the glass, a strong stress is formed in the glass because of the localized densification. This means that ion implantation makes it possible to form a localized stress-applying part.

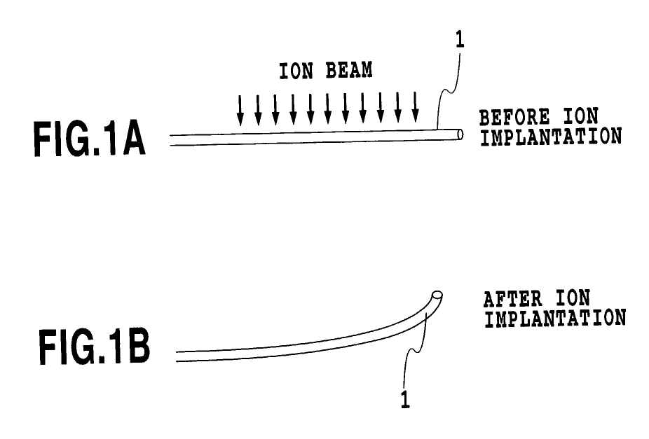

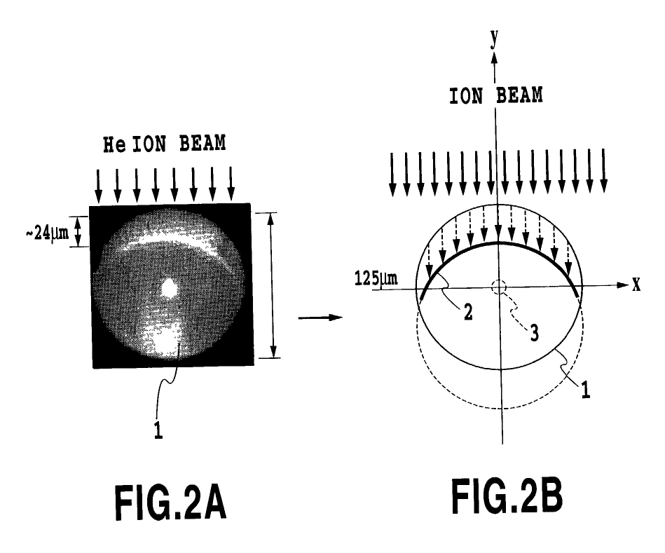

As an experiment to clarify that a strong stress was induced by the densification due to ion implantation, He ions accelerated with 5 MeV were implanted into a side of a commercially available single-mode optical fiber 1 to a dose of 3×10¹⁴ cm⁻² as shown in FIG. 1A. As a result, as shown in FIG. 1B, it was observed that the optical fiber 1 bent toward the direction from which the ions had been irradiated because of the stress induced by the ion implantation. In this case, the densified region generated by the He ions existed around 24 μm inside from the optical fiber surface as shown in FIG. 2A, which illustrates the photograph of the cross section of the optical fiber.

The present inventor found that a polarization-maintaining optical waveguide could be fabricated by forming the densified region, i.e., the stress-applying part 2, around an optical waveguide core 3. Furthermore, the polarization-maintaining effect can be enhanced by forming stress-applying parts 2 at symmetric positions with respect to the optical waveguide core 3 in the same way the conventional PMF.

Now, the preferred embodiments of the present invention will be described in detail below with reference to the accompanying drawings.

[First Embodiment]

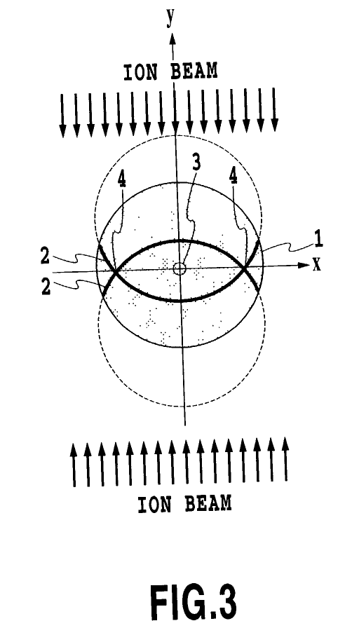

The shape of the stress-applying part 2 formed in the case that ions are implanted into an optical fiber cladding so as to stop in the cladding becomes semicircle having the same curvature as the surface of the optical fiber cladding 1 as indicated in FIG. 2B. The reason is that the ions stop at a certain depth as indicated by the dotted arrows in the case that the ions are implanted along the y axis as shown in FIG. 2b, where the depth is called ‘projected range’, and densification is induced at the position where the ions stop. The present inventor found that the stress-applying parts 2, 2, which are symmetric with respect to the core 3, were formed by utilizing this phenomenon and by irradiating ions into an optical fiber 1 from two directions along the y axis as shown in FIG. 3.

In this case, the core 3 undergoes the stress from all angles, since the stress-applying parts 2, 2 surround the core 3 as seen in FIG. 3. However, since the stress applied by the stress-applying parts 2, 2 decreases with distance from the stress-applying parts 2, 2 exponentially, the stress applied to the core 3 by the stress-applying parts far from x=0 in FIG. 3 is small. Therefore, the birefringence needed to form a polarization-maintaining optical waveguide can be formed.

An example of this invented method will be described below.

When hydrogen ions accelerated with 2.0 MeV are implanted into an optical fiber having a 125 μm diameter silica glass cladding and a 9 μm diameter Ge-doped silica glass core, the hydrogen ions go into the optical fiber to a depth of around 45 μm and stop. As shown in FIG. 3, if the hydrogen ions are implanted from both the upper and lower sides along the y axis, the influence applied to the core 3 by the stress-applying parts at x+±43 μm, i.e., the positions 4, where the two stress-applying parts are crossing, is less than half of the influence applied to the core 3 by the stress-applying part 2 formed at x=0, i.e., on the y axis. In this calculation, it is taken into account that the densification at the positions 4 at x=±43 μm is two times more than that at x=0 because of the two ion beams implanted from different directions. As a result, birefringence is formed in the core 3, and a polarization-maintaining optical waveguide is formed.

The dose of the hydrogen ions is desired to be more than 5×10¹⁵ cm⁻², which is expected to cause the densification of 0.5 to 1% in synthesized silica glass. However, the degree of densification depends on the fabrication method of silica glass and the dopants in silica glass. Therefore, a proper dose should be chosen for each material. The degree of densification per unit implanted dose increases with the atomic numbers of atoms contained in the implanted ions increases. Therefore, an implanted dose can be reduced when ions containing large-atomic number atoms are employed.

[Second Embodiment]

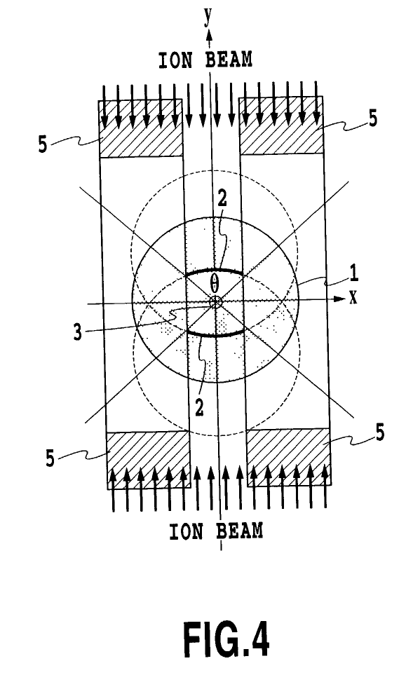

For reducing the influence of the stress at the positions far from x=0 in the above-mentioned fabrication method in the first embodiment of the present invention, ions are implanted only around x=0 in the second embodiment of the present invention by using masks to block out the ions or by reducing the diameter of the ion beam as shown in FIG. 4.

An example of this invented method will be described below.

When hydrogen ions accelerated with 2.0 MeV are implanted into an optical fiber having a 125 μm diameter silica glass cladding and a 9 μm diameter Ge-doped silica glass core, θ in FIG. 4 can be 90 degrees by making the diameter of the ion beam 25 μm and implanting the ions into the optical fiber with the position x=0 as the center. The θ in FIG. 4 of 90 degrees can also be obtained by implanting ions with masking the regions of x>12.5 μm and x<−12.5 μm by masks 5.

[Third Embodiment]

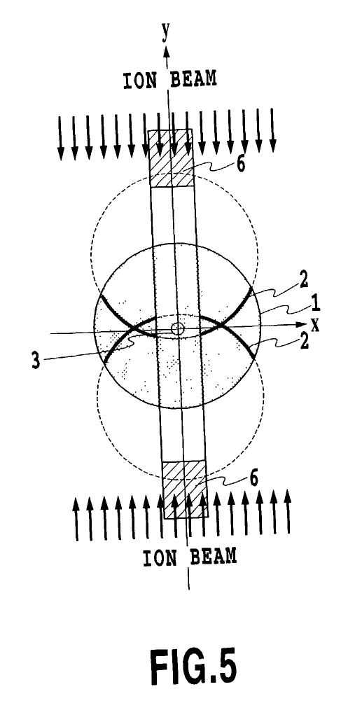

Contrary to the second embodiment, the stress-applying parts 2 can be formed at positions symmetric with respect to the core 3 by masking the region around x=0 using masks 6 as shown in FIG. 5.

An example of this invented method will be described below.

When hydrogen ions accelerated with 2.3 MeV are implanted into an optical fiber having a 125 μm diameter silica glass cladding and a 9 μm diameter Ge-doped silica glass core, the hydrogen ions go into the optical fiber to a depth of around 53 μm and stop. The stress-applying parts 2 being centro-symmetry with respect to the core 3 as shown in FIG. 5 can be obtained, for example, by masking the ion beam with the masks 6 so as to prevent the implantation of the ions into the region of −12.5 μm<x<12.5 μm, and by irradiating the ions.

[Fourth Embodiment]

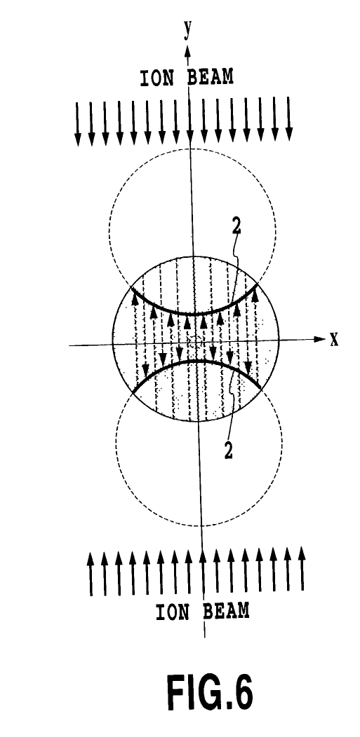

If the acceleration energy is considerable degree, the implanted ions pass through the core and the ions form a semicircular densified portion 2 in the cladding that is on the other side of the core opposite to the cladding surface that the ions are irradiated. Birefringence can be formed in the core by forming a pair of the densified portions 2 as shown in FIG. 6. The masking of the two sides of an optical fiber as shown in FIG. 4 or the masking of the region around x=0 as shown in FIG. 5 is also applicable for this case.

It has been known that when ions pass through silica glass, the ions break atomic bondings in the glass and create defects. In the fabrication method shown in FIG. 6, defects are induced in the core when the ions pass through the core, and the transmission loss of the optical fiber increase. Therefore, in this method, a thermal treatment of the optical fiber around 300° C. after the ion implantation is desirable in order to eliminate the defects.

An example of this invented method will be described below.

When hydrogen ions accelerated with 2.8 MeV are implanted into an optical fiber having a 125 μm diameter silica glass cladding and a 9 μm diameter Ge-doped silica glass core, the hydrogen ions go into the optical fiber to a depth of around 78 μm and stop. By implanting ions from both the upper and the lower directions along the y axis with this ion implantation condition, the stress-applying parts 2 are formed at positions of 15.5 μm apart from the center 3 of the optical fiber in the y-axis direction at x=0 μm.

[Fifth Embodiment]

In all the methods mentioned above, a larger stress can be applied to the core 3 by thickening the stress-applying part 2 by changing the acceleration energy of the ion beam.

An example of this invented method will be described below.

For example, if the acceleration energy of hydrogen ions is varied in the range of 1.7 to 2.0 MeV using the arrangement shown in FIG. 3, the thickness of the stress-applying part 2 becomes around 13 μm. If the acceleration energy changes continuously, the stress-applying part also becomes continuous, while if the acceleration energy changes at an interval of e.g. 0.1 MeV, the stress-applying part is formed discretely. In either case, it is possible to form the birefringence in the core 3.

[Sixth Embodiment]

In all the methods mentioned above, the stress-applying part can be thickened by rotating the optical fiber by a small or minute angle of less than 90 degrees against the ion beam.

An example of this invented method will be described below.

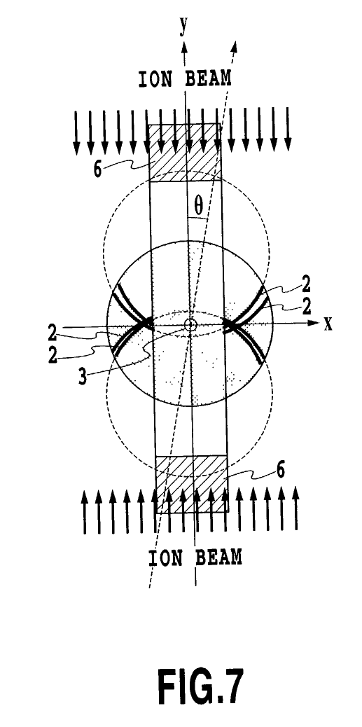

For example, if the optical fiber is tilted with a θ of 10° against the ion beam in the arrangement shown in FIG. 5, the stress-applying part 2 can be thickened as shown in FIG. 7. If the optical fiber is tilted and rotated smoothly during the ion implantation, the stress-applying part becomes a continuous form, while if the optical fiber is tilted and rotated at an interval of e.g. 50, the stress-applying part is formed discretely. In either case, it is possible to form the birefringence in the core 3.

[Seventh Embodiment]

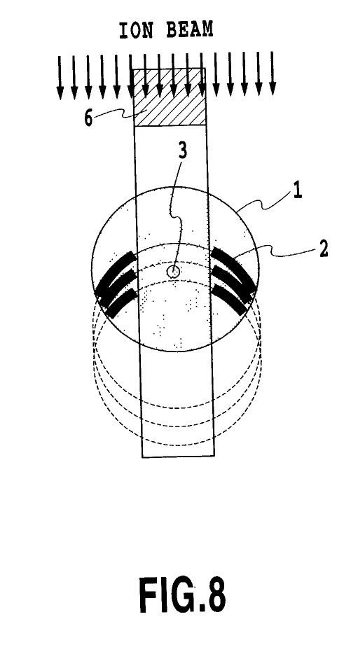

As a modified embodiment of the method shown in FIG. 5, in which an ion beam is irradiated with masking the center of an optical fiber 1 by the mask 6, it is possible to form birefringence in the core 3 by forming thick stress-applying parts 2 by utilizing one-direction ion implantation and changing the acceleration energy and/or tilting the optical fiber against the ion beam, as shown in FIG. 8.

[Eighth Embodiment]

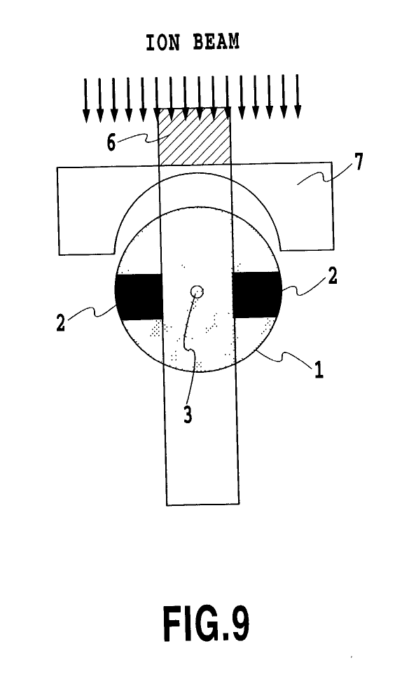

As shown in FIG. 9, if ions are implanted into an optical fiber 1 through a silica glass plate 7 that has a concave surface with the same curvature as the surface of the optical fiber 1, stress-applying parts 2 being centro-symmetry with respect to the core 3 can be formed with one-direction ion implantation.

In this case, it is not necessary that the plate 7 with the concave surface is made of silica glass.

However, if a different material is used for the plate, the projected range of ions in an optical fiber is changed corresponding the material. Therefore, the curvature of the concave surface on the plate should be modified according to the material of the plate.

In any case, any one of the first to the eighth embodiments of the present invention described above, the stress-applying part 2 should be formed all over the optical fiber 1 along the longitudinal direction of the optical fiber. Therefore, the optical fiber 1 should be moved or the ion beam should be scanned in the direction along the longitudinal direction of the optical fiber 1 during the ion implantation.

[Another Embodiment]

In the above, the fabrication of a polarization-maintaining optical waveguide utilizing the ion-implantation-induced densification at an optical waveguide made of silica-based glass is described. The above-described methods are applicable for an optical waveguide made of glass other than silica-based, e.g. compound glass. On the other hand, if an optical waveguide is made of semiconductor materials, ferroelectric materials, and/or ferromagnetic materials, ion implantation may cause expansion in the materials, i.e., a density reduction, because the crystalline states of the materials changes, e.g. crystals become amorphous due to the ion implantation. In this case, a polarization-maintaining structure can be formed by utilizing the stress induced by the expansion of the materials due to the ion implantation.

[Implanted Ions]

In the present invention, any kinds of ions that are able to be accelerated can be used. The ions can be single-atom ions, e.g. H⁺ and He⁺, and molecular ions, e.g. H₂⁺.

The projected ranges of ions with larger atomic numbers become smaller, and the projected ranges of ions with smaller atomic numbers become larger. By utilizing this property, the density-changed region can be widened. For example, if He ions, B ions, and Ge ions are accelerated with 8 MeV and implanted into silica glass, the He ions, B ions, and Ge ions induce the densification at depths of 47, 9, and 4 μm, respectively. For example, if these He, B, and Ge ions are implanted into an optical waveguide in the fabrication method illustrated in FIG. 4, a three-layered densified region 2 is formed, and a higher stress can be applied to the core 3.

In the above, the situation that the acceleration energy is the same for all the ions is described. However, the acceleration energy can be different for each ion. Furthermore, ions of any species can be implanted at the same time. Such an ion beam, containing many kinds of ions, can be obtained by ion generators for ion accelerators, which is currently available on the market.

Generally, the acceleration energy applied to an ion is given by the product of the acceleration voltage applied by an ion accelerator and the charge state of the ion. If He ions are accelerated by an acceleration voltage of 4 MV, acceleration energies of 4 MeV and 8 MeV are given to He^{′} and He²⁺ ions, respectively. In other words, if He ions are accelerated by 4 MV acceleration voltages, He ions accelerated with 4 and 8 MeV are obtained. If an ion beam containing the He ions with two different acceleration energies is irradiated into a silica-based optical waveguide, the ion beam forms the densified region at the depths of 47 and 17 μm. For example, if this He-ion beam containing the He ions with two different acceleration energies is irradiated into an optical waveguide 1 utilizing the fabrication method illustrated in FIG. 4, a two-layered densified region 2 is formed, and a higher stress can be applied to the core 3.

By combining the two above-described methods, i.e., the method that irradiates various kinds of ions and the method that irradiates one kind of an ion with different acceleration energies, much thicker stress-applying parts can be formed within a short time.

The present invention has been described in detail with respect to preferred embodiments, and it will now be apparent from the foregoing to those skilled in the art that changes and modifications may be made without departing from the invention in its broader aspect, and it is the intention, therefore, in the appended claims to cover all such changes and modifications as fall within the true spirit of the invention.

What is claimed is:

1. A polarization-maintaining optical waveguide comprising:
one or more stress-applying parts in a cladding of the optical waveguide formed by implanting accelerated ions into the cladding; and
a core of the optical waveguide in which the stress due to said stress-applying part is applied.

2. The polarization-maintaining optical waveguide as claimed in claim 1, wherein said stress-applying parts are formed at two or more even positions in the cladding to be centro-symmetry with respect to said core.

3. The polarization-maintaining optical waveguide as claimed in claim 1, wherein said stress-applying parts are formed at two or more even positions in the cladding to be line-symmetry with respect to a center line of said core.

4. A fabrication method of a polarization-maintaining optical waveguide comprising the steps of:
generating accelerated ions; and
forming one or more stress-applying parts in a cladding of the optical waveguide that apply a stress to a core of the optical waveguide, by implanting said accelerated ions into said cladding.

5. The fabrication method of the polarization-maintaining optical waveguide as claimed in claim 4, wherein said stress-applying parts are formed at two or more even positions in the cladding to be centro-symmetry with respect to the core, at the stress-applying part forming step.

6. The fabrication method of the polarization-maintaining optical waveguide as claimed in claim 4, wherein said stress-applying parts are formed at two or more even positions in the cladding to be line-symmetry with respect to a center line of the core, at said stress-applying part forming step.

7. The fabrication method of the polarization-maintaining optical waveguide as claimed in claim 4, wherein a region in the optical waveguide where said accelerated ions are implanted is limited by using masks to block out said accelerated ions or by reducing the diameter of said accelerated ion beam, at the stress-applying part forming step.

8. The fabrication method of the polarization-maintaining optical waveguide as claimed in claim 7, wherein said accelerated ions are implanted into the optical waveguide through a plate that has a concave surface with a curvature which is the same or similar to a curvature of a surface of the optical waveguide, at the stress-applying part forming step.

9. The fabrication method of the polarization-maintaining optical waveguide as claimed in claim 4, wherein said stress-applying part is thickened by changing the acceleration energy of said accelerated ion beam, at the stress-applying part forming step.

10. The fabrication method of the polarization-maintaining optical waveguide as claimed in claim 4, wherein plural layers of said stress-applying parts are formed by irradiating ion beams with mixed different acceleration energies into the optical waveguide, at the stress-applying part forming step.

11. The fabrication method of the polarization-maintaining optical waveguide as claimed in claim 4, wherein said stress-applying part is thickened by rotating the optical waveguide against said ion beam at an angle less than 90 degrees, at the stress-applying part forming step.

12. The fabrication method of the polarization-maintaining optical waveguide as claimed in claim 4, wherein plural layers of said stress-applying parts are formed by implanting various kinds of ions at the stress-applying part forming step.

13. A polarization-maintaining optical waveguide fabricated by the fabrication method of the polarization-maintaining optical waveguide comprising the steps of generating accelerated ions, and forming one or more stress-applying parts in a cladding of the optical waveguide that apply a stress to a core of the optical waveguide, by implanting said accelerated ions into said cladding.

14. The polarization-maintaining optical waveguide as claimed in claim 13, wherein a region in the optical waveguide where said accelerated ions are implanted is limited by using masks to block out said accelerated ions or by reducing the diameter of said accelerated ion beam, at the stress-applying part forming step.

15. The polarization-maintaining optical waveguide as claimed in claim 14, wherein said accelerated ions are implanted into the optical waveguide through a plate that has a concave surface with a curvature which is the same or similar to a curvature of a surface of the optical waveguide, at the stress-applying part forming step.

16. The polarization-maintaining optical waveguide as claimed in claim 13, wherein said stress-applying part is thickened by changing the acceleration energy of said accelerated ion beam, at the stress-applying part forming step.

17. The polarization-maintaining optical waveguide as claimed in claim 13, wherein plural layers of said stress-applying parts are formed by irradiating ion beams with mixed different acceleration energies into the optical waveguide, at the stress-applying part forming step.

18. The polarization-maintaining optical waveguide as claimed in claim 13, wherein said stress-applying part is thickened by rotating the optical waveguide against said ion beam at an angle less than 90 degrees, at the stress-applying part forming step.

19. The polarization-maintaining optical waveguide as claimed in claim 13, wherein plural layers of said stress-applying parts are formed by implanting various kinds of ions at the stress-applying part forming step.
